(19) United States
(12) Patent Application Publication
(10) Pub. No.: US 2010/0325156 A1
(43) Pub. Date: Dec. 23, 2010

(54) SYSTEMS AND METHODS FOR SECURE DATA ENTRY AND STORAGE

(76) Inventor: Bhagyarekha Plainfield, Portland, OR (US)

Correspondence Address: KOLISCH HARTWELL, P.C., 200 PACIFIC BUILDING, 520 SW YAMHILL STREET, PORTLAND, OR, 97204, US

(21) Appl. No.: 12/517,943

(22) PCT Filed: May 27, 2009
(86) PCT No.: PCT/US09/45331

§ 371 Date: Jun. 5, 2009

Related U.S. Application Data
(60) Provisional application No. 61/056,771, filed on May 28, 2008.

(51) Int. Cl. G06F 17/30

(52) U.S. Cl. 707/770; 707/783; 707/E17.014; 707/E17.01

(57) ABSTRACT

Systems, computer systems, methods and storage media are disclosed for secure distribution and/or storage of data, as well as for secure data entry. In one embodiment, a processor of a control computer system is configured to: generate a first portion of the first data file; communicate over a network interface the first portion of the first data file to a network location; store in a database an association between the first portion of the first data file and the first data file; receive over the network interface a communication related to the first portion of the first data file; and associate the communication related to the first portion of the first data file with the first data file based upon the association between the first portion and the first data file.

### CROSS REFERENCE TO RELATED APPLICATIONS

This application claims priority under 35 U.S.C. §119(e) to U.S. Provisional Patent Application No. 61/056,771 entitled “Fracturing Image Files for Secure Storage and/or Distribution,” filed May 28, 2008, the disclosure of which is incorporated herein by reference.

### BACKGROUND

A single document or piece of data representing a document may have multiple pieces of information contained within. It may be desirable to separate these pieces of information from one another for security, data gathering, or other similar purposes.

For example, information often is gathered using fillable forms. The Internal Revenue Service delivers tax forms to taxpayers to fill out, either by hand or by computer (e.g., form-fillable PDF files). Credit card companies send out fillable application forms to potential customers, and bills to existing customers, which the existing customers may fill in and return (often with a check). Other businesses may allow customers to purchase products using fillable purchase orders on which the customer fills in payment information. Such fillable forms are often returned in paper form. Accordingly, it is often necessary to extract the filled in data from the filled-in forms, applications, checks or purchase orders, and input the data into computer databases.

Sets of filled-in forms, either in paper form or in computer image files, may be delivered to data processing entities for input into computer databases. Some data processing entities employ data entry workers to manually read data from filled-in forms for entry into a computer database. Other data processing entities may be equipped with optical character recognition (“OCR”) equipment with which data may be automatically extracted from image files.

A security issue arises where a data processing entity receives filled-in forms containing confidential data which could be used maliciously. For example, a purchase order might contain a customer's name, address, credit card number and the credit card expiration date. A tax form might contain a taxpayer's Social Security number, address and other information. While any one of these pieces of information alone may not be valuable, in combination the pieces of information can be used for malicious purposes. For example, a credit card number alone is useless. However, a data entry worker at a data processing entity could combine the credit card number with a customer name, address and expiration date in order to use the credit card maliciously.

In other scenarios, a single document may have multiple pieces of information that are useful to different parties. For example, an auction listing in a newspaper may include data of interest to auctioneers, sellers, buyers, and the like. Wills and trusts may have sections that give property to particular persons. It may be desirable for a party interested in a particular piece of information to receive only that piece of information, and not the other pieces of information in the document.

### BRIEF DESCRIPTION OF THE DRAWINGS

FIG. 1 depicts an example user-filled form with multiple pieces of potentially confidential information.

FIG. 2 depicts how one or more discrete portions of the user-filled form of FIG. 1 may be generated, so that they may be separated and/or communicated to separate locations.

FIG. 3 depicts an example secure data entry system.

FIG. 4 depicts schematically the components of a control computer system according to an embodiment of the disclosure.

FIG. 5 depicts steps for generating templates and using the templates to generate portions of data files for secure distribution, storage and/or data entry.

FIG. 6 depicts steps for distributing the portions generated in FIG. 5 to various remote entities.

FIG. 7 depicts steps for reassembling portions and/or data extracted from portions.

### DETAILED DESCRIPTION

Systems, computer systems, methods and storage media for storing computer-readable programs are disclosed herein for generating, from original data files, portions of the original data files for secure storage, distribution and/or data entry, as well as reassembling some or all of the portions and/or data extracted from the portions, at a later time.

A data file is a stream of bits that represents any type of data, including image, audio, text, multimedia, and the like. Although in most of the embodiments and examples described herein, data files are image files, it should be understood that the disclosed systems and methods may be used with other types of data.

Image files may be in various formats, such as Tagged Image File Format (“TIFF”), JPEG, Graphics Interface Format (“GIF”), bitmap, Portable Document Format (“PDF”), Cartesian Perceptual Compression (“CPC”), Portable Network Graphics (“PNG”), and the like. Although image files having standard dimensions (e.g., 8.5″ by 11, A4) will be most common, image files having other dimensions also may be manipulated as described herein.

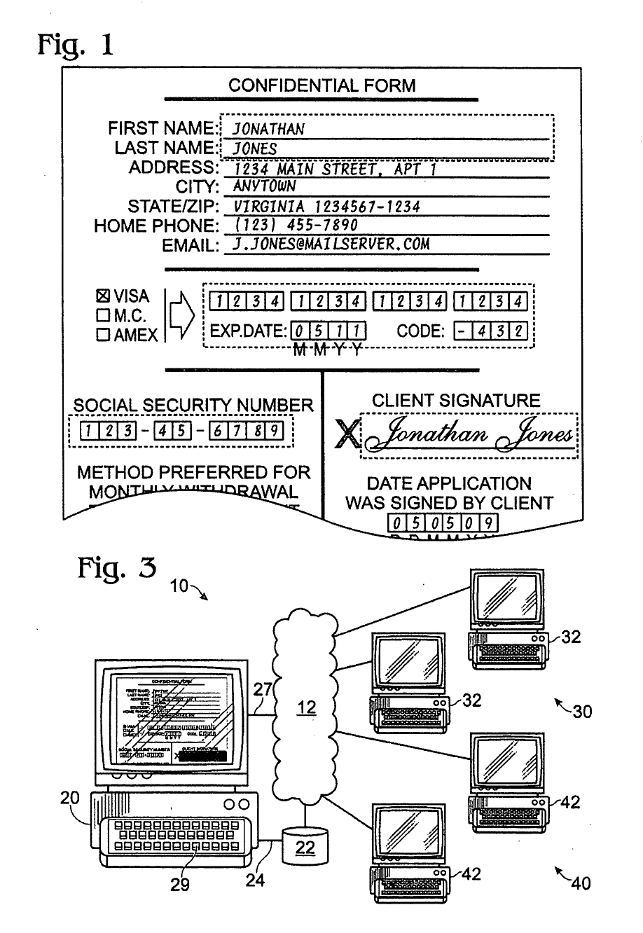

FIG. 1 depicts an example data file, in this case an image file, that includes an electronic representation of an example fillable form. Various pieces of information about an individual are filled in, including: the individual's name; address; credit card information, including credit card number and expiration date; the individual's Social Security number; and the individual's signature.

Individually, these pieces of information may be meaningless and not traceable to the individual who filled in the form. For example, credit card information may be less useful without the individual's name, and in some cases, the individual's address. Similarly, a Social Security number may not be useable without the individual's name. However, various combinations of these individual pieces of information potentially could be linked to the individual who filled in the form and used maliciously. For instance, an identity thief could use an individual's name, address and Social Security number to steal the individual's identity.

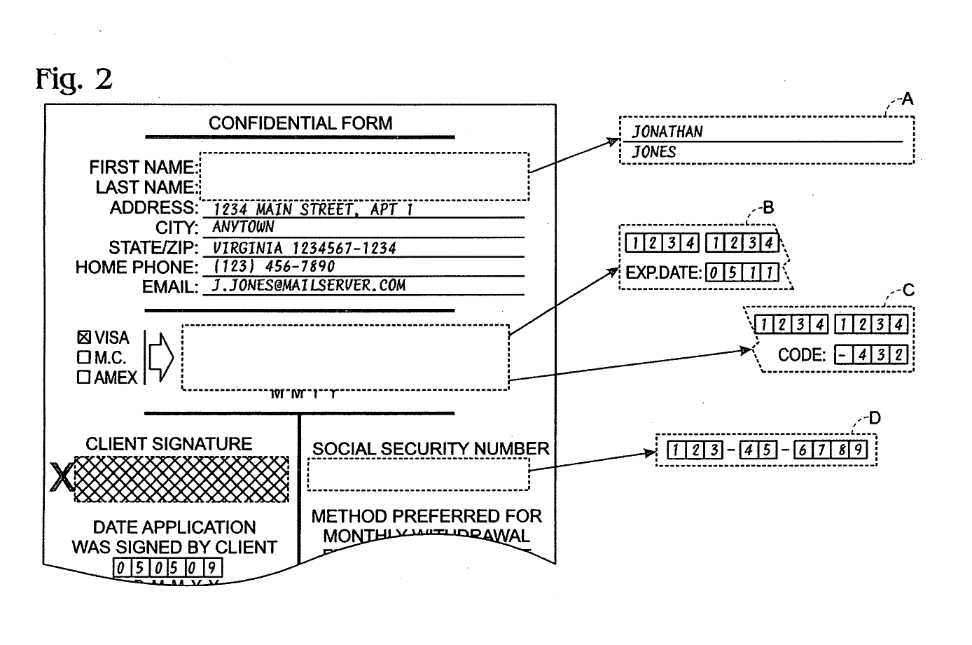

FIG. 2 depicts one example of how discrete portions of the image file of FIG. 1 may be generated in order to isolate them from one another. In this example, the region of the image file containing the individual's name is generated into portion A. Regions containing the first and second halves of the individual's credit card information are generated into portions B and C, respectively. The region containing the individual's Social Security number is generated into portion D. Portions A-D will be referred to continuously in the examples below.

Generating a portion of a data file may include creating a separate file, in the same format as the data file or in a different format that includes less than the entire data file. Thus, a portion of a data file may be a continuous section of the data file, a copy of the data file with subsections or regions excluded, or a combination of both. In embodiments where portions include the original data file with sections excluded, the excluded sections may simply be “cut out” of the original data file. If the data file is an image file, the excluded sections may be redacted.

FIG. 3 depicts one embodiment of a secure data entry system 10. A computer network 12 connects multiple computer systems that may be operated together to implement secure data storage, distribution and/or data entry. Although referred to herein in the singular, computer network 12 may be one or more interconnected local area or wide area networks, including the Internet.

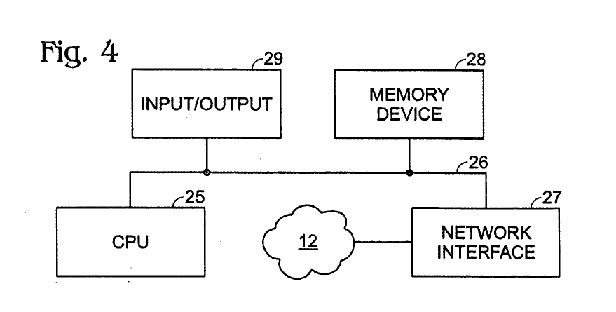

Secure system 10 may include a control computer system 20, which may also be referred to as a data storage computer system, and a database 22. An example control computer system 20 is depicted schematically in FIG. 4, and includes at least one processor 25. Control computer system 20 may be in communication to computer network 12 by virtue of its processor 25 being operably coupled via a bus 26 to a network interface 27, which may be a wired or wireless interface. Processor 25 of control computer system 20 also may be operably coupled via bus 26 to other typical components, including memory devices 28 such as hard discs, solid-state data storage devices, RAM and ROM, input and output devices 29 such as monitors, keyboards and mice, and so on.

Referring back to FIG. 3, database 22 may be incorporated into control computer system 20 or may be a separate computer or computers connected to control computer system 20 via a direct connection 24 or through one or more networks via a network interface 27. Database 22 may be implemented in various ways. In simple systems, database 22 may be an ordinary data file that contains data in binary or ASCII (e.g., *.txt) form. In exemplary systems, database 22 may be any number of commercially available databases, such as Oracle, MySQL, Microsoft SQL Server, Microsoft Access, and the like.

Access to database 22 may be restricted to authorized users to prevent unauthorized reassembly of portions and/or data associated with an original data file. Database 22 may be secured in various ways, such as by requiring a credential such as a password, digital certificate, or other more sophisticated credentials (e.g., biometric scan, RFID badge) to obtain access. In some cases, more than one user may be required to log into database 22 simultaneously to access particularly sensitive data.

As will be described in further detail below, after control computer system 20 generates portions of a data file, such as portions A-D shown in FIG. 2, control computer system 20 may communicate the portions to one or more data entry computer systems (indicated generally at 30). Each of the one or more data entry computer systems 30 may include one or more computers configured to receive portions of data files from sources such as control computer system 20, extract data from the portions, and communicate the extracted data to computer systems such as control computer system 20.

Each data entry computer system 32 may provide for the extraction of data from portions in various fashions. For example, each data entry computer system 32 may be under the control of one or more data entry workers. The worker may view the received portions and input the observed information into a database or data file. Alternatively, a data entry computer system 32 may be configured to perform OCR on the received portions to extract information.

Additionally or alternatively, control computer system 20 may be configured to communicate portions of data files to one or more network storage locations (indicated generally at 40). Each network storage location 42 may be a computer system similar to those described above. Each network storage location 42 also may be in communication of the other components of secure data entry system 10 via computer network 12.

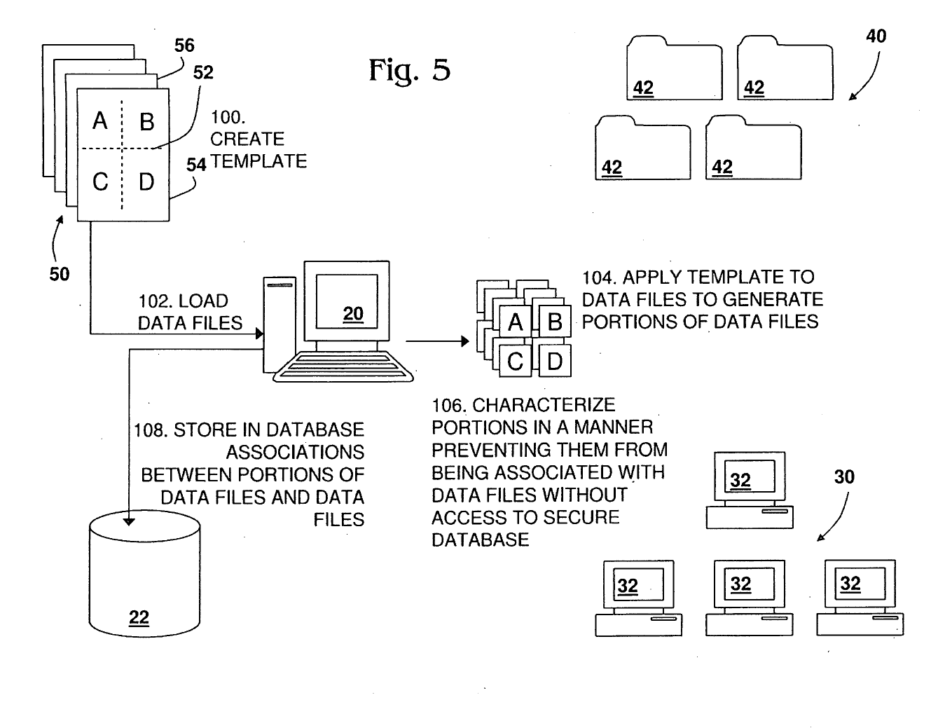

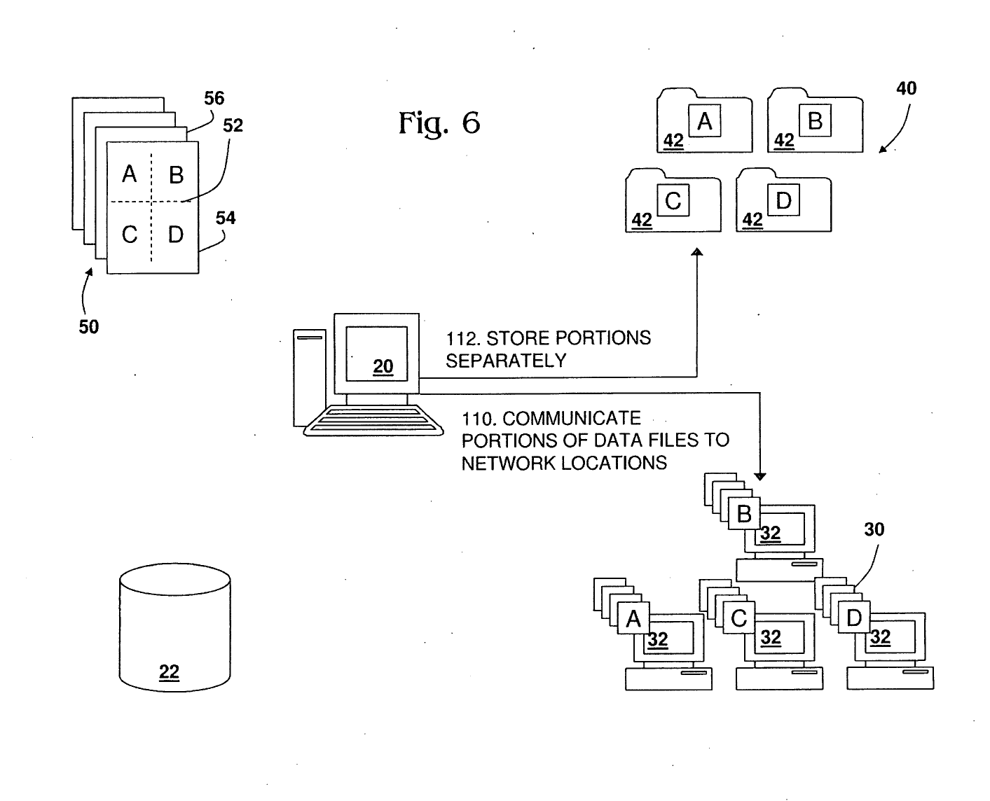

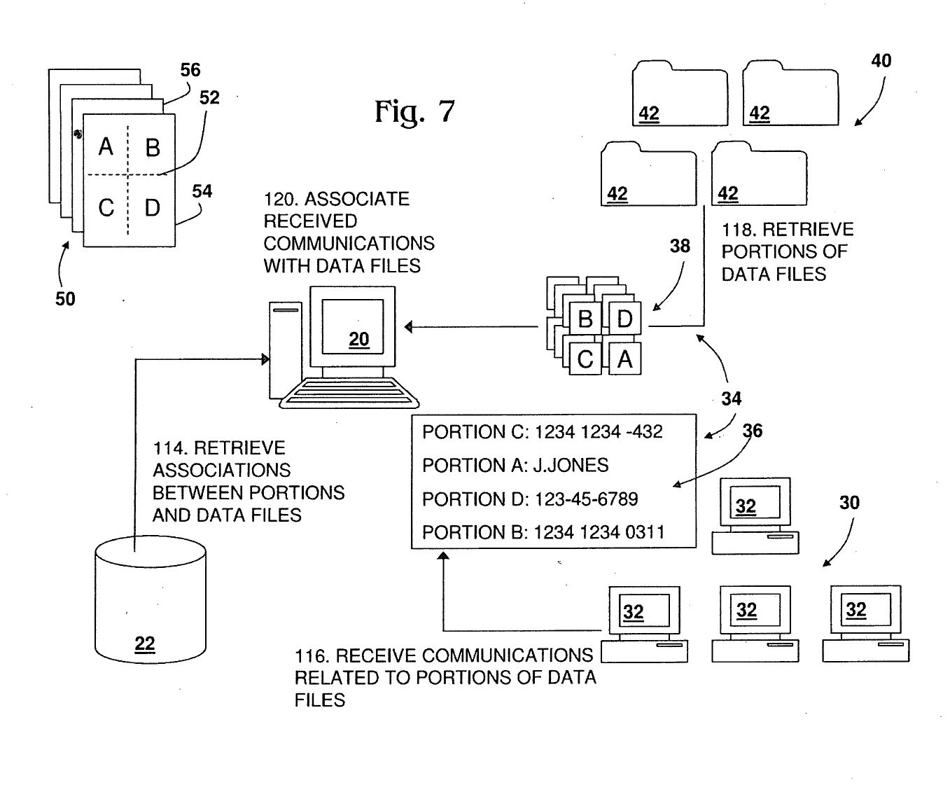

Example processes of generating portions of a set (indicated generally at 50) of data files for distribution are depicted in FIG. 5. Example processes of securely distributing generated portions are depicted in FIG. 6. Example processes of retrieving portions, storing data extracted therefrom in database 22 and reassembling portions into original data files are shown in FIG. 7. Although the steps are shown in a particular order, this is not meant to be limiting, and the steps may occur in various orders not depicted in the drawings, and some steps may be performed simultaneously, or not at all.

In step 100 of FIG. 5, a user creates a template 52 for generating portions of each of the set 50 of image files. Template 52 may be a computer file stored in memory containing computer-readable instructions of how portions of a data file are to be generated. In some embodiments, template 52 is stored in database 22 or in another portion of memory that is secured in a manner similar to database 22. In some embodiments, template 52 is created at control computer system 20. In other embodiments, template 52 may be created remotely and uploaded to control computer system 20. For example, control computer system may provide a web user interface that allows a user anywhere on the Internet to log in, create a template 52, and upload the template to control computer system 20.

Portions of the original data files intended for secure storage and/or distribution may be defined by a user using a graphical user interface (“GUI”) or other similar means. In embodiments where the original data files are image files, the GUI may be configured to display a representative original image file as a backdrop on which regions may be selected for generation into portions. A representative original image file may be selected in a number of ways. For example, the GUI may be configured to allow the selection of a source folder containing the set 50 of original image files and to display a single original image file (e.g., the first file in the folder) as a backdrop.

Portions of the original image file may be selected using standard input devices (e.g., input/output 29 of FIG. 4). For example, portions may be selected by dragging a mouse over a desired area of the original image file, such as the area containing a piece of information (e.g., all or part of a credit card number). As noted above, portions may be any size less than or equal to the original image file's area. Portions may also overlap. In some embodiments, portions are defined in template 52 by the geometric coordinates of the portion within the original image file. The term “geometric coordinates” as used herein is not meant to be limited to geometric shapes, but may include any defined area or space of an image file. Such defined spaces may be freehand spaces, which may be defined by a series of geometric points, or other spaces commonly found in graphic design and image manipulation programs.

Templates 52 may be edited, deleted or copied. When editing template 52, the same first image file that was used as a backdrop when creating the template may be displayed again as a backdrop. The regions of the original image file selected for generation of portions and/or exclusion when the template was created may be shown once again superimposed over the image, such as with colored and/or transparent shapes.

As noted above, in some embodiments, portions of original image files may include regions of the original image files that are excluded or blocked. In such embodiments, excluded regions may be created using similar techniques (e.g., using a mouse to drag a rectangle over the desired area of the original image file) as are used to define the portions to be generated. Excluded regions and portions also may overlap, so that portions include blocked regions.

Referring back to FIG. 5, in step 102, the set 50 of image files may be loaded into memory of control computer system 20. In step 104, a processor of control computer system 20 may apply template 52 to one or more of the set 50 of original image files to generate one or more portions of each image files. For example, assuming the set 50 of image files are similar to the image file depicted in FIGS. 1 and 2, template 52 may be applied to a first image file 54 to generate a first portion A, a second portion B, a third portion C and a fourth portion D, of first image file 54.

Because the set 50 includes more than one image file, template 52 may be applied to a second image file 56, generating additional A, B, C and D portions, and so on, until template 52 has been applied to all the image files in set 50. As noted above, template 52 may include geometric coordinates defining the regions of the image files, and so when template 52 is applied to multiple image files, corresponding portions of multiple image files may be generated using a single set of geometric coordinates. For example, if each image file in set 54 includes an individual's Social Security number in the same region, that region may be defined in template 52, and a corresponding portion, similar to D shown in FIG. 2, may be generated for each image file of the set 50.

Using traditional image manipulation software (e.g., Adobe® Photoshop®) to create computer files containing portions of image files can be tedious. Accordingly, in some embodiments, the portions generated in step 104 may be saved as individual computer files merely for the sake of convenience, and not for security's sake.

A series of image files may contain filled-in forms having pieces of information of varying size. For example, each individual's first name and last name may vary in size and style based on number of letters per name, as well as handwriting in examples where the form is not filled in with a computer. Accordingly, portions of the original image files may be selected that will allow for pieces of information which may vary in size.

For example, a portion selected to capture a first name may be seven or eight centimeters long. While shorter first names may not require seven or eight centimeters of space, it may be preferable to accidentally capture a portion of the immediately adjacent last name, rather than lose a portion of a longer first name. Another portion may be defined to capture the last name as well, and it may overlap with the portion designed to capture the first name because where the first name is short, the last name will be positioned differently than if the first name is long.

In some examples, each image file may be a multi-page image file, and portions may be defined from one or more pages of the multi-page image file: For example a first portion, as defined in template 52, may include a region of a first page of the multi-page image file. Similarly, a second portion, as defined in template 52, may include a region of a second page of the multi-page image file.

In some embodiments, control computer system 20 may utilize template 52 later to reassemble portions into original image files. In such cases, once template 52 has been applied to set 50 of original image files, as shown at step 104, template 52 may be locked from editing and/or deleting using a flag or other similar mechanism. This protects template 52 from being altered before a user has had an opportunity to reassemble the portions into the original data files.

Continuing with the process depicted in FIG. 5, in step 106, the generated portions (e.g., A-D) are characterized in a manner that prevents association with the original image file from which the portions were generated without access to database 22. To this end, each portion may be assigned an identifier that is unrelated to the original image file from which the portion was generated, but is associable with the original image file using information contained in database 22. For example, each portion may be assigned a filename comprised of randomly generated numbers and characters that, without access to database 22, is not relatable with the original image file from which the portion was generated.

In step 108, an association between each portion and the image file from which it was generated may be stored in database 22. For example, each image file may be assigned an identifier (e.g., a filename) in database 22. Likewise, each portion may be assigned an identifier, such as the randomly-generated filename described above. In some cases, the original image file's filename or identifier may be a key, or even the primary key, into database 22. Accordingly, the identifier of any portion generated from an image file may be stored in database 22 in association with the image file's identifier.

Referring now to FIG. 6, the portions generated from the set 54 of image files may be communicated to various locations for secure storage and/or data entry. In most embodiments, these portions are communicated to the various locations accompanied and/or identified by their identifiers.

In step 110, the generated portions are communicated to the one or more data entry computer systems 30. A first data entry computer system 32 receives all the “A” portions (i.e. the portions of the image files containing the individuals' names). A second data entry computer system 32 receives all the “B” portions (i.e. the portions of the image files containing the first halves of the individuals' credit card information). A third data entry computer system 32 receives all the “C” portions (i.e. the portions of the image files containing the second halves of the individuals' credit card information). A fourth data entry computer system 32 receives all the “D” portions (i.e. the portions of the image files containing the Social Security number).

In an exemplary embodiment, the portions sent to each data entry computer system 32 are shuffled so that they cannot be associated with portions sent to another data entry computer system 32. For example, the “B” portions may be received in a different order (e.g., randomly shuffled) than the “C” portions, so that a user of the data entry computer system 32 receiving the “B” portions cannot collaborate with a user of the data entry computer system 32 receiving the “C” portions to associate “B” portions with “C” portions.

Moreover, in embodiments where the portions contain computer-printed text, rather than handwritten text, so long as each set of portions (e.g., the “A” portions) is shuffled to a different order than the other sets of portions (e.g., the “B,” “C,” or “D” portions), all portions may be sent to a single data entry computer system 32, and it will be prohibitively difficult, if not impossible, for a user of that computer system to relate the portions to one another.

In some embodiments, the portions received by the one or more data entry computer systems 30 include handwritten text. A user at each data entry computer system 32 may be trained to read each portion and convert the handwritten data to its computer-readable equivalent by inputting the handwritten data into data entry computer system 32 via an input device 29 such as a keyboard. As will be described below, the computer-readable data may then be returned to, or retrieved by, control computer system 20 for storage in database 22.

Additionally or alternatively, control computer system 20 may in step 112 store portions it generates in one or more remote network locations 40. As noted above, these portions may be characterized in a manner so that they cannot be associated with the image files from which they were generated without access to the database.

As an additional security measure, portions may be communicated to different network locations in a manner that prevents them from being associated with each other without access to database 22. For example, the A portions described above may be communicated to a first network location, and the B and C portions may be communicated to a second location that is remote from the first network location. In yet other embodiments, portions may be communicated to the same network location in a manner that prevents them from being associated with one another without access to database 22. For example, the order of portions may be altered so that they may be communicated to the same network location without compromising security.

After portions of the set 50 of image files have been distributed, whether to data entry computer systems 30 or remote network storage locations 40, control computer system 20 may be configured to reassemble the portions and/or assemble data associated with the portions into database 22. FIG. 7 depicts two different processes that may be implemented by control computer system 20 to reassemble portions or gather information extracted from portions.

In step 114, control computer system 20 retrieves one or more associations it stored in database 22 in step 108. Step 114 may be performed prior to retrieving portions or data from remote locations, or it may be performed in response to receiving a communication associated with one or more portions.

In steps 116 and 118, control computer system 20 receives a communication 34 related to one or more portions it generated previously. Receiving communication 34 may include control computer system 20 actively requesting and obtaining communication 34 (e.g., via a FTP or SFTP transfer), or may include control computer system 20 passively awaiting communication 34. In either case, communication 34 may be a stream of bits containing information related to one or more portions. Communication 34 may be received/retrieved using any number of computer communication methods (e.g., FTP, bittorrent, HTTP, SMTP), or using more traditional communication means (e.g., a physical magnetic or optical disk hand-delivered or received via mail).

Communication 34 received/retrieved by control computer system 20 may contain various types of information associated with portions of data files. For example, in step 116 of FIG. 7, control computer system 20 receives or retrieves from the one or more data entry computer systems 30 communication 34 including information 36 extracted from the portions communicated to the one or more data entry computer systems 30 in step 110. Communication 34 may include the extracted information 36 in various formats, including comma delimited or XML. Additionally or alternatively, in step 118, control computer system 20 receives or retrieves portions 38 generated (e.g., in step 104) previously by control computer system 20 from remote network locations 40.

Where communication 34 contains information 36 extracted from portions, as indicated at step 116, in step 120, control computer system 20 may be configured to associate communication 34 with one or more original image files. For example, the communication 34 may include the identifier of each portion along with the information 36 extracted therefrom, and database 22 may have stored within an association between the identifier of each portion and an identifier of an original image file from which the portion was generated. Accordingly, control computer system 20 may associate the information extracted from each portion with the identifier of the original image file from which the portion was generated by using the associations retrieved in step 114. Once control computer system 20 has made this association, it may store in database at least one datum of the information extracted from the portion in association with the original image file. In this way, secure data entry is achieved.

Additionally or alternatively, if communication 34 contains returned portions 38, as indicated at step 118, rather than information 36 extracted from portions, control computer system 20 may be configured to associate, in step 120, communication 34 with one or more original image files (as described above). For example, communication 34 may include the A, B, C and D portions discussed previously, with their associated identifiers. As shown in FIG. 7, these portions would most likely be received in a different order than they were generated.

A report of the portions received in step 118 may be generated. This report may be compared to a report indicating which generated portions were sent originally, so that it can be determined whether all generated portions were retrieved. Control computer system 20 may receive less than all the portions generated from an original image file. In some such embodiments, reassembly of the portions into the original image files may be prevented until all portions are retrieved.

In some embodiments, control computer system 20 may store the received/retrieved portions 38 separately, for later reassembly. In some such embodiments, control computer system may provide a user interface for assigning one or more fields to each portion. These assigned fields may be stored in database 22, so that a user may search database 22 by field to retrieve portions containing that field.

For example, the B and C portions described above, which contain the first and second halves of an individual's credit card information, respectively, may be assigned a field called “Credit Card Information.” A user who later searches for “Credit Card Information” will receive only the portions assigned the “Credit Card Information” field, including the B and C portions. In some instances, the portions retrieved in the search may be reassembled relative to one another in the same way they were located relative to one another in their original image file. In this way, a user may view a piece of each image file (e.g., credit card information), without reassembling the entire image file.

Fields may be assigned security permissions so that particular users may only view particular fields. For example, portions assigned fields such as “first name,” “hobbies,” “emergency contact,” and other information that is unlikely to be security-sensitive may be searchable and viewable by users having a low level of clearance. In contrast, an administrator may be allowed to search and view more security-sensitive fields such as “credit card information” or “social security number.”

Some control computer systems 20 may be configured to generate portions for storage, assign the portions fields, and store the portions locally at control computer system 20. In such cases, it is not required that control computer system 20 send the portions to data entry computer systems 30 or remote network locations 40. Rather, the fields of the stored portions may be assigned permissions, and data entry users of various security levels may use control computer system 20 locally to enter data into database 22.

For example, a low level data entry worker may log on and search for “first name” and “emergency contact.” Only portions of each original image file having been assigned these fields will appear, and the low level user may input this data into database 22. In some cases, these portions may be superimposed on a blank area (e.g., black) that is the same size as the original image file, with the portions in their respective positions of the original image files. Later, a higher security level user may log in to control computer system 20 and search for “social security numbers.” The portions of the original image files assigned this field may appear, and the high security level person may then input Social Security numbers into database 22.

The disclosure set forth above may encompass multiple distinct embodiments with independent utility. The specific embodiments disclosed and illustrated herein are not to be considered in a limiting sense, because numerous variations are possible. The subject matter of this disclosure includes all novel and nonobvious combinations and subcombinations of the various elements, features, functions, and/or properties disclosed herein. The following claims particularly point out certain combinations and subcombinations regarded as novel and nonobvious. Other combinations and subcombinations of features, functions, elements, and/or properties may be claimed in applications claiming priority from this or a related application. Such claims, whether directed to a different invention or to the same invention, and whether broader, narrower, equal, or different in scope to the original claims, also are regarded as included within the subject matter of the inventions of the present disclosure.

Where the claims recite “a” or “a first” element or the equivalent thereof, such claims include one or more such elements, neither requiring nor excluding two or more such elements. Further, ordinal indicators, such as first, second or third, for identified elements are used to distinguish between the elements, and do not indicate a required or limited number of such elements, and do not indicate a particular position or order of such elements unless otherwise specifically stated.

What is claimed is:

1. A computer system, comprising:
a memory device storing an executable program and data, including a first data file and a database;
a network interface to a computer network having one or more network communication devices; and
a processor operably coupled to the network interface and configured to:
generate a first portion of the first data file;
communicate over the network interface the first portion of the first data file to a network communication device;
store in the database an association between the first portion of the first data file and the first data file;
receive over the network interface a communication related to the first portion of the first data file; and
associate the communication related to the first portion of the first data file with the first data file based upon the association between the first portion and the first data file.

2. The computer system of claim 1, wherein the processor is further configured to characterize the first portion of the first data file in a manner that prevents association with the first data file without access to the database.

3. The computer system of claim 2, wherein the association between the first portion of the first data file and the first data file includes a first identifier identifying the first data file and a second identifier identifying the first portion of the first data file, wherein the processor is further configured to communicate the second identifier to the network communication device, and wherein the communication related to the first portion of the first data file includes the second identifier.

4. The computer system of claim 3, wherein the processor is further configured to store, in association with the first identifier, at least one datum from the communication related to the first portion of the first data file.

5. The computer system of claim 4, wherein the at least one datum is not a portion of the first data file.

6. The computer system of claim 5, wherein the at least one datum includes a computer-readable equivalent of handwritten text contained in the first portion of the first data file.

7. The computer system of claim 2, wherein the processor is further configured to:
generate a second portion of the first data file;
store in the database an association between the second portion of the first data file and the first data file;
characterize the second portion of the first data file' in a manner that prevents association with the first data file without access to the database;
communicate over the network interface the second portion of the first data file to a network communication device;
receive over the network interface a second communication related to the second portion of the first data file;
associate the communication related to the second portion of the first data file with the first data file based upon the association between the second portion of the first data file and the first data file.

8. The computer system of claim 7, wherein the first and second portions of the first data file are communicated to different network communication devices in a manner that prevents them from being associated with one another without access to the database.

9. The computer system of claim 7, wherein the first and second portions of the first data file are communicated to the same network communication device in a manner that prevents them from being associated with one another without access to the database.

10. The computer system of claim 7, wherein the first data file is a multi-page image file, and wherein the first portion of the first data file is a portion of a first page of the multi-page image file, and the second portion of the first data file is a portion of a second page of the multi-page image file.

11. The computer system of claim 1, wherein the first portion of the first data file is defined in a template, and generating the first portion of the first data file includes applying the template to the first data file.

12. The computer system of claim 11, wherein the first data file is an image file, and the first portion of the first data file is defined in the template by a set of geometric coordinates.

13. The computer system of claim 12, wherein the memory device further includes a second data file, and wherein the processor is further configured to:
apply the template to the second data file to generate a first portion of the second data file;
communicate over the network interface the first portion of the second data file to the same network communication device as the first portion of the first data file;
store in the database an association between the first portion of the second data file and the second data file;
receive over the network interface a communication related to the first portion of the second data file; and
associate the communication related to the first portion of the second data file with the second data file based upon the association between the first portion of the second data file and the second data file.

14. The computer system of claim 13, wherein the second data file is an image file, and the first portion of the first data file and the first portion of the second data file are defined in the template by the same set of geometric coordinates.

15. The computer system of claim 14, wherein geometric coordinates of the template define a region of the first and second data files that is excluded from the first portions of the first and second data files.

16. The computer system of claim 15, wherein the excluded regions in the first portions of the first and second data files are redacted.

17. The computer system of claim 11, wherein once the template is used to generate the first portion of the first data file, the template is locked from editing.

18. The computer system of claim 1, wherein access to the database is restricted to authorized users.

19. The computer system of claim 1, wherein the processor is further configured to:
store in the database an association between the first portion of the first data file and a first field;
receive a search request containing one or more fields; and
generate an output containing the first portion of the first data file when the search request includes the first field.

20. A storage medium for storing a computer-readable program executable by a computer, the program causing the computer to perform the functions of:
applying a template to plurality of image files to generate first and second sets of portions of the plurality of image files, each portion of the first set including a first region of an image file of the plurality of image files, and each portion of the second set including a second region of an image file of the plurality of image files;
storing in a database an association between each portion in the first and second sets and the image file from which the portion was generated;
characterizing each portion in the first and second sets in a manner that prevents association with the image file from which the portion was generated without access to the database;
communicating over a network interface the first set to a first network communication device and the second set to a second network communication device;
receiving over the network interface a communication containing data related to the first set and a communication containing data related to the second set; and
associating data from the received communications to the plurality of image files based upon the stored associations.

21. A secure data entry system, comprising a data storage computer system and a data entry computer system connected by a computer network, wherein:
the data storage computer system is configured to:
apply a template to a first data file to generate a first portion of the data file;
store in a database an association between the first portion of the first data file and the first data file;
characterize the first portion of the first data file in a manner that prevents association with the first data file without access to the database;
communicate to the data entry computer system the first portion of the first data file;
receive from the data entry computer system a communication related to the first portion of the first data file; and
associate the communication related to the first portion of the first data file with the first data file based upon the association between the first portion of the first data file and the first data file;
and the data entry computer system is configured to:
receive from the data storage computer system the first portion of the first data file;
provide for the extraction of data from the first portion of the first data file; and
communicate to the data storage computer system the data extracted from the first portion of the first data file.

22. The secure data entry system of claim 21, further comprising a second data entry computer system wherein:
the data storage computer system is further configured to:
apply the template to the first data file to generate a second portion of the first data file;
store in the database an association between the second portion of the first data file and the first data file;
characterize the second portion of the first data file in a manner that prevents association with the first data file without access to the database;
communicate the second portion of the first data file to the second data entry computer system;
receive from the second data entry computer system a second communication related to the second portion of the first data file;
associate the communication related to the second portion of the first data file with the first data file based upon the association between the second portion of the first data file and the first data file;
and the second data entry computer system is further configured to:
receive the second portion of the first data file from the data storage computer system;
provide for the extraction of data from the second portion of the first data file; and
communicate to the data storage computer system the data extracted from the second portion of the first data file.

23. The secure data entry system of claim 21, wherein:
the data storage computer system is further configured to:
apply the template to a second data file to generate a first portion of the second data file;
store in the database an association between the first portion of the second data file and the second data file;
characterize the first portion of the second data file in a manner that prevents association with the second data file without access to the database;
communicate to the data entry computer system the first portion of the second data file;
receive from the data entry computer system a communication related to the first portion of the second data file; and
associate the communication related to the first portion of the second data file with the second data file based upon the association between the first portion of the second data file and the second data file;
and the data entry computer system is further configured to:
receive the first portion of the second data file from the data storage computer system;
provide for the extraction of data from the first portion of the second data file; and
communicate to the data storage computer system the data extracted from the first portion of the second data file.

24. The secure data entry system of claim 21, wherein providing for the extraction of data from the first portion of the first data file includes performing optical character recognition on the first portion of the first data file.

25. The secure data entry system of claim 21, wherein the data storage computer system is further configured to:
store in the database an association between the first portion of the first data file and a first field;
receive a search request containing one or more fields; and
generate an output containing the first portion of the first data file when the search request includes the first field.
